(19) United States
(12) Patent Application Publication
(10) Pub. No.: US 2023/0073772 A1
(43) Pub. Date: Mar. 9, 2023

(54) WRENCH EXTENDER

(71) Applicant: Hong Ann Tool Industries Co., Ltd., Taichung City (TW)

(72) Inventor: Cheng-Wei SU, Taichung City (TW)

(21) Appl. No.: 17/894,330

(22) Filed: Aug. 24, 2022

(30) Foreign Application Priority Data
Sep. 3, 2021 (TW) 110132891
Nov. 10, 2021 (TW) 110141888

(51) Int. Cl. B25G 1/00; B25G 1/06

(52) U.S. Cl. CPC B25G 1/005; B25G 1/063

(57) ABSTRACT

A wrench extender includes an extension member and a retaining member. The extension member has a wrench supporting base with a supporting face and first and second sides adjacent to the supporting face and respectively disposed at two opposite sides of the supporting face. The wrench supporting base is provided with a first holding portion arranged on the supporting face and adjacent to the first side, and a second holding portion arranged on the supporting face and adjacent to the second side. The retaining member is arranged on the wrench supporting base to retain a wrench hold by the wrench supporting base.

### BACKGROUND

The present invention relates to a wrench extender and, more particular, to a wrench extender for increasing torque applicable.

Taiwan Design Patent No. TWD189623 discloses a tool grip with two different type ends, where one end being like an open-end wrench, and the other end being like a box-end wrench.

The main advantage of the above wrench is to provide two different driving types. However, because the user's hand can only grip between the two ends of the wrench to cause the force arm being short, the user needs to use other auxiliary extension tool attach to the wrench for increasing the force arm, but the connection of the auxiliary extension tool and the wrench is limited due to the complex shape of the wrench, so that the auxiliary extension tool cannot be stably connected to the wrench.

Thus, a need exists for a novel wrench extender to mitigate and/or obviate the above disadvantages.

### SUMMARY

An objective of the present invention is to provide a wrench extender including an extension member. The extension member has a wrench supporting base with a supporting face and first and second sides adjacent to the supporting face and respectively disposed at two opposite sides of the supporting face. The wrench supporting base is provided with a first holding portion arranged on the supporting face and adjacent to the first side, and a second holding portion arranged on the supporting face and adjacent to the second side.

In an embodiment, the wrench extender further includes a retaining member arranged on the wrench supporting base to retain a wrench hold by the wrench supporting base.

In an embodiment, the retaining member has a mounting portion connected to the second holding portion, and a retaining portion extended from the mounting portion.

In an embodiment, the mounting portion and the retaining portion are perpendicular each other.

In an embodiment, the second holding portion has a threaded hole. The mounting portion has a penetrating hole aligned to the threaded hole, and a threaded fastener inserts through the penetrating hole and secures with the threaded hole.

In an embodiment, the wrench supporting base further has a recess formed on the supporting face, and the wrench extender further includes a magnetic member fixedly arranged in the recess.

In an embodiment, the recess is disposed between the first holding portion and the second holding portion.

In an embodiment, the extension member further has an extending portion extended from the wrench supporting base, and the wrench extender further includes a handle pivotally connected to the extending portion.

In an embodiment, a first holding channel is defined between the supporting face and the first holding portion, and a second holding channel is defined between the supporting face and the second holding portion.

In an embodiment, the second holding channel is inclined with respect to the first holding channel.

In an embodiment, a distance defined between the first side and the second side is greater than a distance defined between the first side and a top edge of the first holding portion.

In another embodiment, the retaining member has a mounting portion connected to the first holding portion, and a retaining portion extended from the mounting portion.

In another embodiment, the mounting portion and the retaining portion are perpendicular each other.

In another embodiment, the second holding portion further has a recess formed on an inner wall thereof, and the wrench extender further includes a magnetic member fixedly arranged in the recess.

In another embodiment, the recess is disposed between the second side and a top edge of the second holding portion.

In another embodiment, a distance defined between the first side and the second side is less than a distance defined between the first side and a top edge of the second holding portion.

The present invention will become clearer in light of the following detailed description of illustrative embodiments of this invention described in connection with the drawings.

### BRIEF DESCRIPTION OF THE DRAWINGS

FIG. 1 is a perspective view of a wrench extender of a first embodiment according to the present invention.

FIG. 2 is an enlarged partial exploded perspective view of the wrench extender of FIG. 1.

FIG. 3 is a cross sectional view of the wrench extender of FIG. 1 and shows a retaining member mounted on a second holding portion.

FIG. 4 is another cross sectional view of the wrench extender of FIG. 1 and shows a magnetic member mounted to a recess of a wrench supporting base.

FIG. 5 is a perspective view of the wrench extender of FIG. 1 and shows the wrench extender hold a wrench.

FIG. 6 is a partial perspective view of a wrench extender of a second embodiment according to the present invention.

FIG. 7 is another partial perspective view of the wrench extender of FIG. 6.

FIG. 8 is another perspective view of the wrench extender of FIG. 6.

### DETAILED DESCRIPTION

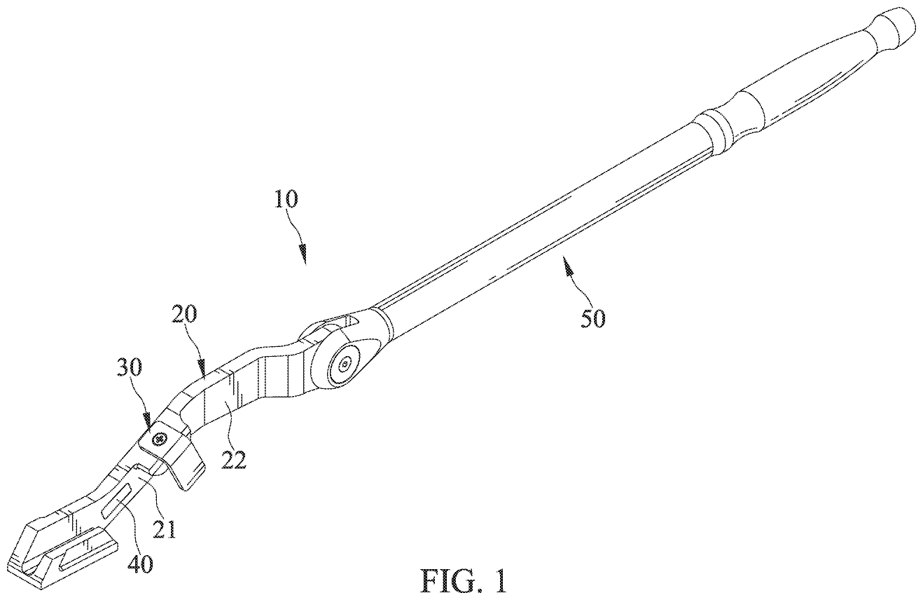

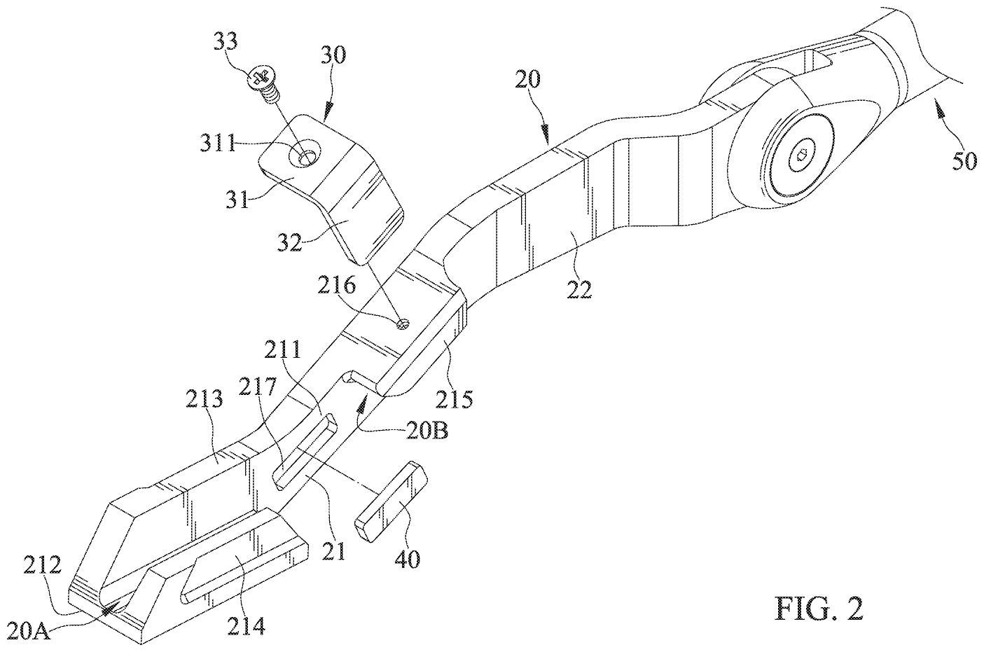

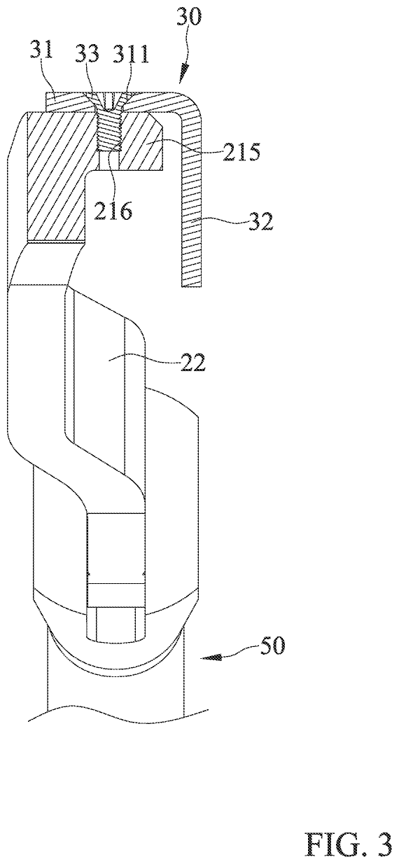

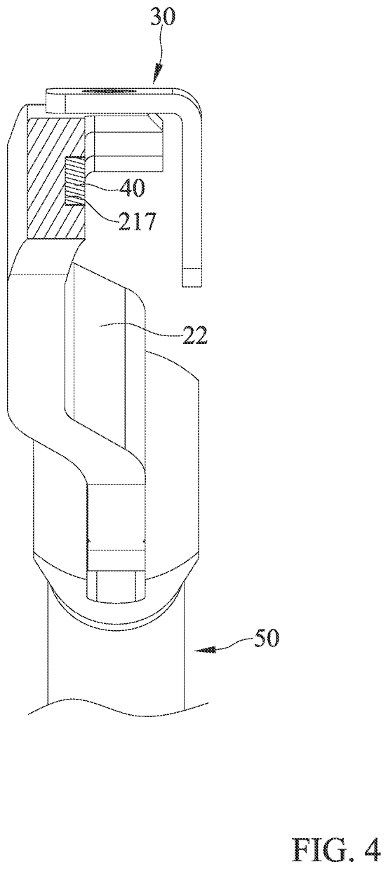

FIGS. 1-5 show a wrench extender 10 of a first embodiment according to the present invention. The wrench extender 10 includes an extension member 20 and a retaining member 30. The extension member 20 has a wrench supporting base 21 with a supporting face 211 and first and second sides 212, 213 adjacent to the supporting face 211 and respectively disposed at two opposite sides of the supporting face 211. The wrench supporting base 21 is provided with a first holding portion 214 arranged on the supporting face 211 and adjacent to the first side 212, and a second holding portion 215 arranged on the supporting face 211 and adjacent to the second side 213. The retaining member 30 is arranged on the wrench supporting base 21 to retain a wrench 60 hold by the wrench supporting base 21.

The retaining member 30 has a mounting portion 31 connected to the second holding portion 215, and a retaining portion 32 extended from the mounting portion 31. Further, the mounting portion 31 and the retaining portion 32 may be perpendicular each other so that the retaining member 30 is formed as an L-shaped structure.

In order to connect the mounting portion 31 of the retaining member 30 to the second holding portion 215 of the wrench supporting base 21, the second holding portion 215 has a threaded hole 216, the mounting portion 31 has a penetrating hole 311 aligned to the threaded hole 216, and a threaded fastener 33 inserts through the penetrating hole 311 and secures with the threaded hole 216.

Further, the wrench supporting base 21 further has a recess 217 formed on the supporting face 211, and the wrench extender 10 further includes a magnetic member 40 fixedly arranged in the recess 217. Thus, the magnetic member 40 can magnetically attract the wrench 60 when the wrench 60 hold by the wrench supporting base 21. Furthermore, the recess 217 may be disposed between the first holding portion 214 and the second holding portion 215.

In the embodiment, the extension member 20 further has an extending portion 22 extended from the wrench supporting base 21, and the wrench extender 10 further includes a handle 50 pivotally connected to the extending portion 22.

A first holding channel 20A is defined between the supporting face 211 and the first holding portion 214, and a second holding channel 20B is defined between the supporting face 211 and the second holding portion 215. In the embodiment, the second holding channel 20B is inclined with respect to the first holding channel 20A.

Further, a distance defined between the first side 212 and the second side 213 is greater than a distance defined between the first side 212 and a top edge of the first holding portion 214.

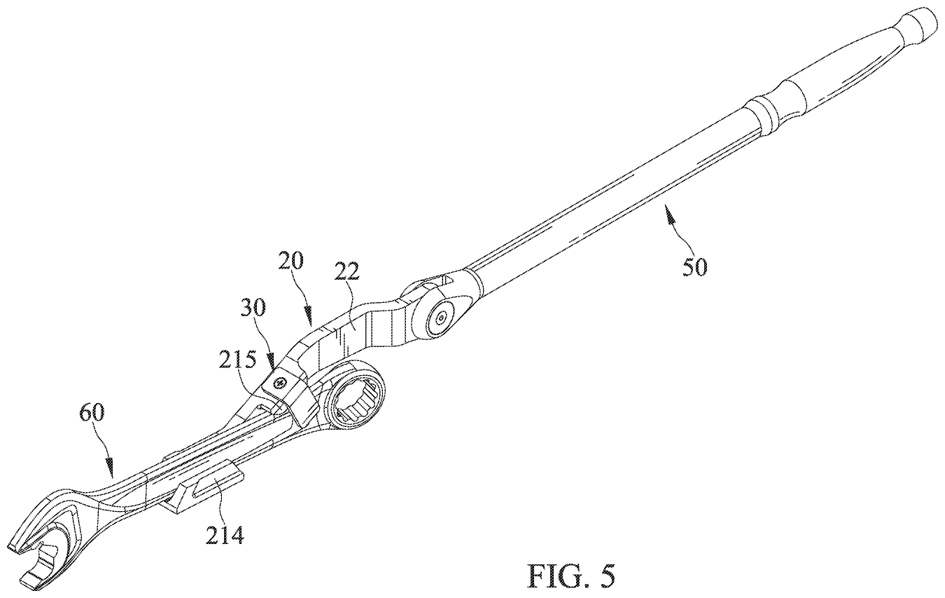

As such, as shown in FIG. 5, when the wrench 60 is attached to the wrench supporting base 21 to be hold in the first holding channel 20A and the second holding channel 20B, the middle portion of the wrench 60 is held by the first holding portion 214, and the right potion adjacent to the box-end of the wrench 60 is held by the second holding portion 215 and the retaining member 30. In addition, the magnetic member 40 can magnetically attract the wrench 60. Thus, the wrench 60 is stably held by the wrench supporting base 21 and is not easy to detach therefrom due to force or shaking.

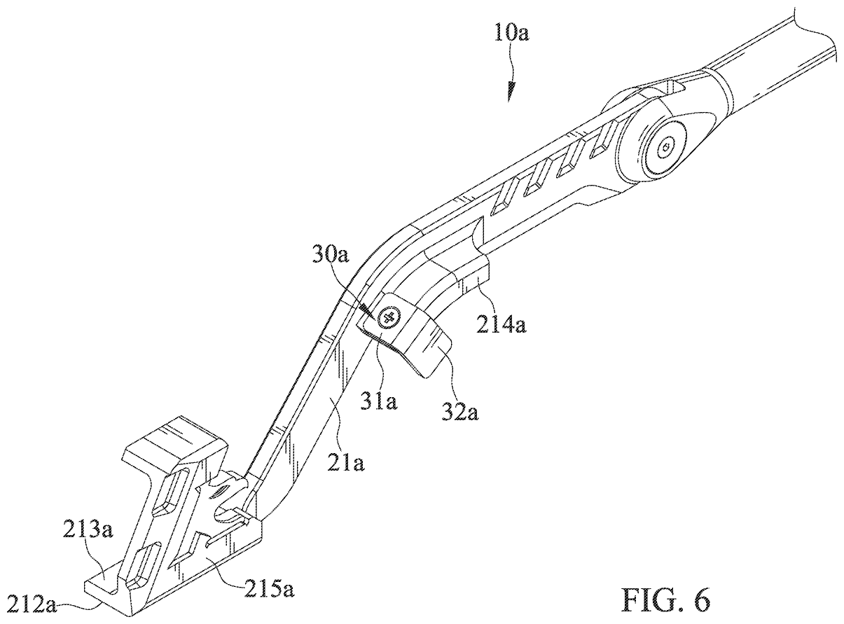

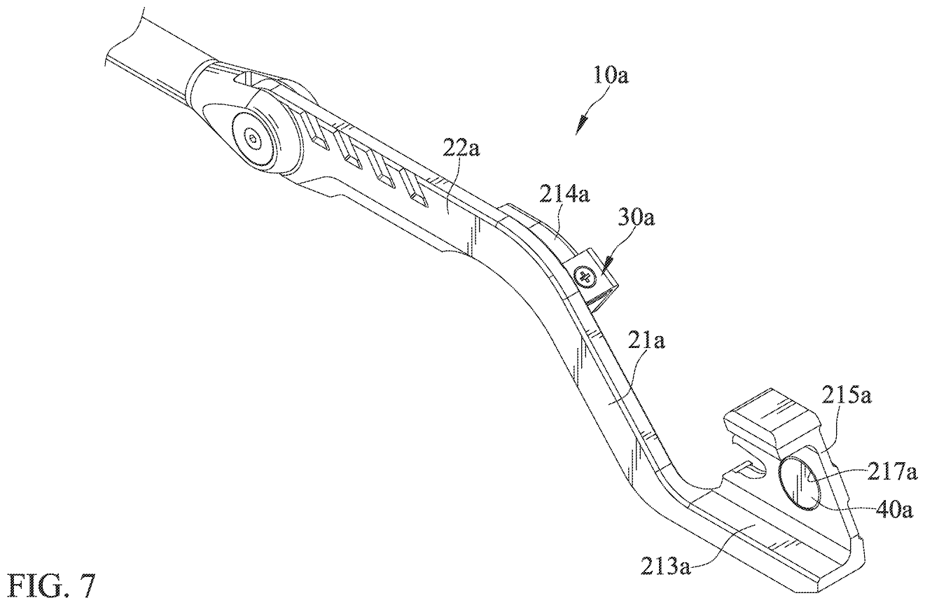

FIGS. 6-8 show a wrench extender 10a of a second embodiment according to the present invention. The second embedment is substantially the same as the first embodiment. The main differences are that the retaining member 30a has a mounting portion 31a connected to the first holding portion 214a, and a retaining portion 32a extended from the mounting portion 31a. Further, the mounting portion 31a and the retaining portion 32a are perpendicular each other.

The second holding portion 215a further has a recess 217a formed on an inner wall thereof, and the wrench extender 10a further includes a magnetic member 40a fixedly arranged in the recess 217a. Further, the recess 217a is disposed between the second side 213a and a top edge of the second holding portion 215a.

Furthermore, a distance defined between the first side 212a and the second side 213a is less than a distance defined between the first side 212a and a top edge of the second holding portion 215a.

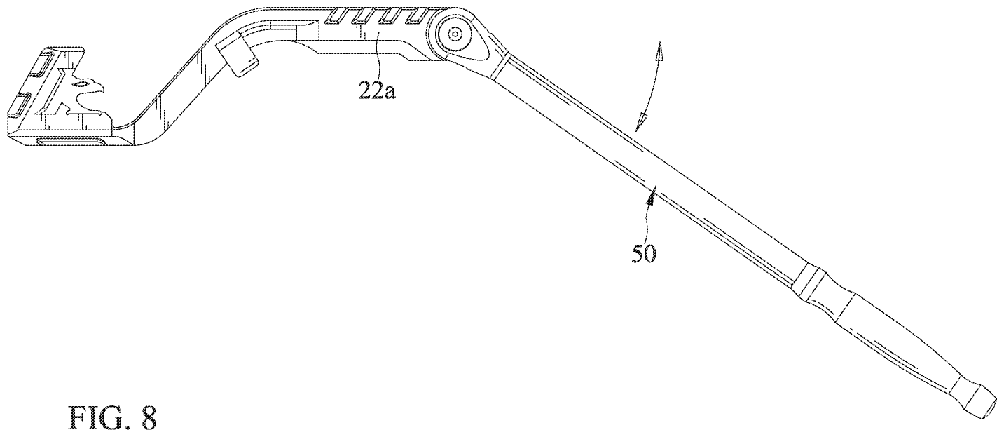

FIG. 8 shows the extending portion 22a can be selectively adjusted the varying included angle with respect to the handle 50. A locking mechanism may be arranged between the extending portion 22a and the handle 50.

Although specific embodiments have been illustrated and described, numerous modifications and variations are still possible without departing from the scope of the invention. The scope of the invention is limited by the accompanying claims.

1. A wrench extender comprising:
an extension member having a wrench supporting base with a supporting face and first and second sides adjacent to the supporting face and respectively disposed at two opposite sides of the supporting face, wherein the wrench supporting base is provided with a first holding portion arranged on the supporting face and adjacent to the first side, and a second holding portion arranged on the supporting face and adjacent to the second side.

2. The wrench extender as claimed in claim 1, further comprising:
a retaining member arranged on the wrench supporting base to retain a wrench hold by the wrench supporting base.

3. The wrench extender as claimed in claim 2, wherein the retaining member has a mounting portion connected to the second holding portion, and a retaining portion extended from the mounting portion.

4. The wrench extender as claimed in claim 3, wherein the mounting portion and the retaining portion are perpendicular each other.

5. The wrench extender as claimed in claim 3, wherein the second holding portion has a threaded hole, wherein the mounting portion has a penetrating hole aligned to the threaded hole, and wherein a threaded fastener inserts through the penetrating hole and secures with the threaded hole.

6. The wrench extender as claimed in claim 1, wherein the wrench supporting base further has a recess formed on the supporting face, and wherein the wrench extender further includes a magnetic member fixedly arranged in the recess.

7. The wrench extender as claimed in claim 6, wherein the recess is disposed between the first holding portion and the second holding portion.

8. The wrench extender as claimed in claim 1, wherein the extension member further has an extending portion extended from the wrench supporting base, and wherein the wrench extender further includes a handle pivotally connected to the extending portion.

9. The wrench extender as claimed in claim 1, wherein a first holding channel is defined between the supporting thee and the first holding portion, and wherein a second holding channel is defined between the supporting face and the second holding portion.

10. The wrench extender as claimed in claim 9, wherein the second holding channel is inclined with respect to the first holding channel.

11. The wrench extender as claimed in claim 1, wherein a distance defined between the first side and the second side is greater than a distance defined between the first side and a top edge of the first holding portion.

12. The wrench extender as claimed in claim 2, wherein the retaining member has a mounting portion connected to the first holding portion, and a retaining portion extended from the mounting portion.

13. The wrench extender as claimed in claim 12, wherein the mounting portion and the retaining portion are perpendicular each other.

14. The wrench extender as claimed in claim 2, wherein the second holding portion further has a recess formed on an inner wall thereof, and wherein the wrench extender further includes a magnetic member fixedly arranged in the recess.

15. The wrench extender as claimed in claim 14, wherein the recess is disposed between the second side and a top edge of the second holding portion.

16. The wrench extender as claimed in claim 1, wherein a distance defined between the first side and the second side is less than a distance to defined between the first side and a top edge of the second holding portion.

17. A wrench extender comprising:
an extension member having a wrench supporting base with a supporting face and first and second sides adjacent to the supporting face and respectively disposed at two opposite sides of the supporting face, wherein the wrench supporting base is provided with a first holding portion arranged on the supporting face and adjacent to the first side, and a second holding portion arranged on the supporting face and adjacent to the second side;
a handle pivotally connected to the extension member; and
a locking mechanism arranged between the extension member and the handle.
